(19) United States
(12) Patent Application Publication
(10) Pub. No.: US 2022/0242184 A1
(43) Pub. Date: Aug. 4, 2022

(54) Device with driven wheels having variable inclination

(71) Applicants: Vanni Boccato, Adria (RO) (IT); Stefano Camilla, Adria (RO) (IT)

(72) Inventor: Vanni Boccato, Adria (RO) (IT)

(21) Appl. No.: 17/636,970

(22) PCT Filed: Aug. 25, 2020
(86) PCT No.: PCT/IB2020/057921

§ 371 Date: Feb. 21, 2022

(30) Foreign Application Priority Data
Aug. 29, 2019 (IT) 102019000015216

(51) Int. Cl. B60G 3/20; B60K 17/32; B62D 9/00; B62D 15/00; B60K 1/02

(52) U.S. Cl. CPC B60G 3/20; B60K 17/32; B62D 9/00; B62D 15/00; B60K 7/0007; B60G 2200/44; B60G 2200/46; B60G 2200/4622; B60G 2300/40; B60K 1/02

(57) ABSTRACT

A moving system includes a first driving wheel and a second driving wheel associated to a supporting structure and rotatable to move the system forward or backward on a supporting surface. The first and the second driving wheel each include a spherical portion, the first driving wheel being rotatable around a first rotation axis and the second driving wheel being rotatable around a second rotation axis. The moving system further includes an inclination system that varies the inclination of the first rotation axis of the first driving wheel and/or of the second rotation axis of the second driving wheel so as to vary the diameter of the rotation circumference formed by the points of contact with the ground.

The present patent relates to drive systems in general.

In particular, the present patent relates to a drive system that can be associated with vehicles, such as automobiles, robotic systems, automated integrated systems, automated materials handling vehicles, systems for exploration and work in hazardous environments, exploration and work in the space sector, rescue and handling of persons with disabilities, operator controlled vehicles for the handling of heavy materials, remote control systems.

The prior art includes vehicles, both for the transport of humans and for the handling of materials, such as cars, trucks, etc., wheeled systems comprising at least two wheels driven in rotation by endothermic engines or electric motors.

To allow the variation of the vehicle speed, the prior art includes gear systems, or gearboxes, with the function of changing the transmission ratio between the wheels and the engine in order to enable the latter work at optimal rotation speeds when varying the vehicle speed.

Furthermore, to enable the vehicle to turn, differential systems are used to distribute the rotation between the wheels enabling them to rotate at different speeds during a turn.

Further mechanisms are also used to complete the transmission and motorization system, such as clutches, universal joints, transmission shafts, bevel gears, etc. that enable the vehicle to function correctly.

The object of the new invention is to propose a new drive system as an alternative to known systems.

Furthermore, another object of the invention is to propose a new drive system that can be used in various handling sectors, such as automobiles, robotic systems, automated integrated systems, automated materials handling vehicles, systems for exploration and work in hazardous environments, exploration and work in the space sector, rescue and handling of persons with disabilities, operator controlled vehicles for the handling of heavy materials, remote control systems.

These and other direct and complementary objects are achieved by the new drive system comprising a first driving wheel and a second driving wheel associated with a support structure and suited to be rotated for the forward or backward movement of said system on a support surface in which said first driving wheel is made up of at least one spherical portion and said second driving wheel is made up of at least one spherical portion, said first driving wheel being rotated around a first axis of rotation and said second driving wheel being moved in rotation around a second axis of rotation, in which said system comprises inclination means suited to vary the inclination of said first axis of rotation of said first driving wheel and/or of said second axis of rotation of said second driving wheel so that the diameter of the circumference of rotation formed by the points of contact with the supporting surface varies.

The invention is particularly advantageous in that by varying the inclination, with the consequent variation in the diameter of the rotation circumference constituted by the points of contact with the ground (P), the stall torque changes.

According to a preferred embodiment, the inclination means set the first axis of rotation and the second axis of rotation with the same inclination with respect to the support surface to enable the forward or backward movement along a rectilinear direction of the system.

Preferably, the inclination means vary the inclination of said first axis of rotation and of said second axis of rotation by the same angle simultaneously, causing a variation of the moving speed of said system with the same speed of rotation of said first driving wheel and of said second driving wheel.

In a preferred embodiment, the inclination means set the first axis of rotation and the second axis of rotation with different inclinations with respect to said support surface to allow forward or reverse movement along a curved trajectory of the system.

According to a preferred embodiment, the first driving wheel and/or the second driving wheel is rotated by means of electric or hydraulic drive means.

Preferably, the electric drive means are installed directly on the corresponding first driving wheel and/or second driving wheel.

In a preferred embodiment, the inclination means comprise system configured as an articulated parallelogram.

According to a preferred embodiment, the support structure corresponds to at least a part of the frame of a vehicle.

From another standpoint, the invention relates to a method for controlling the trajectory and/or the moving speed of a system of the type described above, comprising the following steps:
the arrangement of said first axis of rotation and said second axis of rotation with the same inclination with respect to said support surface to enable the forward or backward movement of said system along a rectilinear direction at a given speed or vary by the same amount said same inclination with respect to said support surface of said first axis of rotation and of said second axis of rotation to enable the variation of the forward or backward movement speed of said system along a rectilinear direction; or
the arrangement of said first axis of rotation and said second axis of rotation with different inclinations with respect to said support surface to enable the forward or backward movement of said system along a curved trajectory.

From yet another standpoint, the invention relates to a vehicle comprising a drive system having at least two driving wheels in which the drive system is realized as described above.

Preferably, the vehicle is of the type such as automobiles, robotic systems, automated integrated systems, automated vehicles for the handling of materials, systems for exploration and work in hazardous environments, exploration and work in the space sector, rescue and handling of persons with disabilities, man controlled vehicles for the handling of heavy materials, remote control systems.

From yet another standpoint, the invention relates to a method for controlling the trajectory and/or the translation speed of a system of the type described above, in which the method comprises:
the arrangement of said first axis of rotation and said second axis of rotation with the same inclination with respect to said support surface to enable the forward or backward movement of said system along a rectilinear direction at a given speed or to vary by the same amount said same inclination with respect to said support surface of said first axis of rotation and said second axis of rotation to enable the variation of the forward or backward moving speed of said system along a rectilinear direction; or
the arrangement of said first axis of rotation and said second axis of rotation with different inclinations with respect to said support surface to enable the forward or backward movement of said system along a curved trajectory.

The characteristics of the present invention will be better clarified by the following description with reference to the drawings, attached by way of a non-limiting example, where:

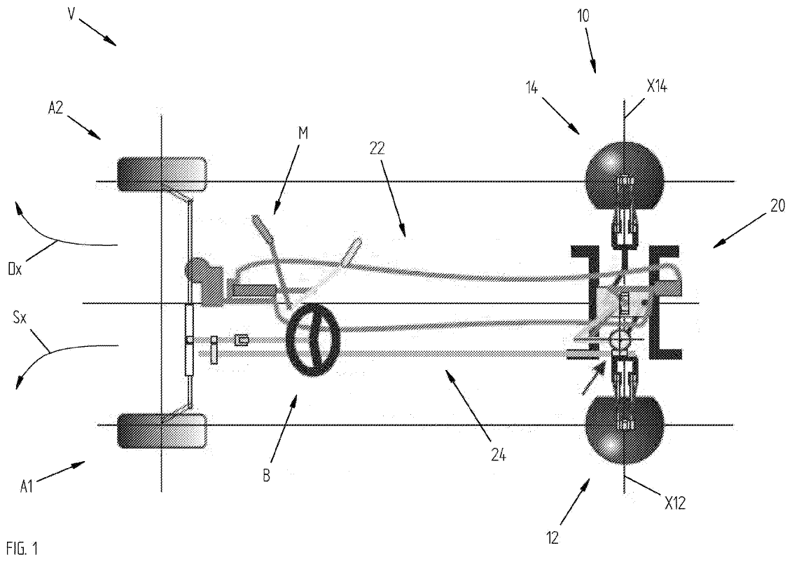

FIG. 1 shows a schematic top view of a vehicle equipped with a drive system according to a preferred embodiment of the invention;

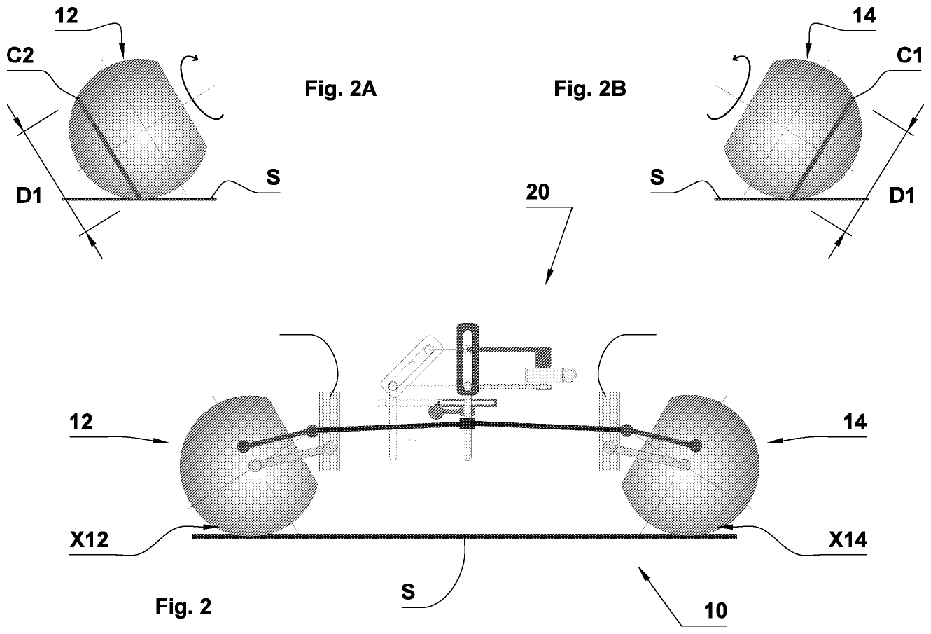

FIG. 2 shows a schematic view of a drive system according to a preferred embodiment of the invention in a first operating position for the movement of the system along a rectilinear direction at a first moving speed;

FIG. 2A shows a first detail of FIG. 2;

FIG. 2B shows a second detail of FIG. 2;

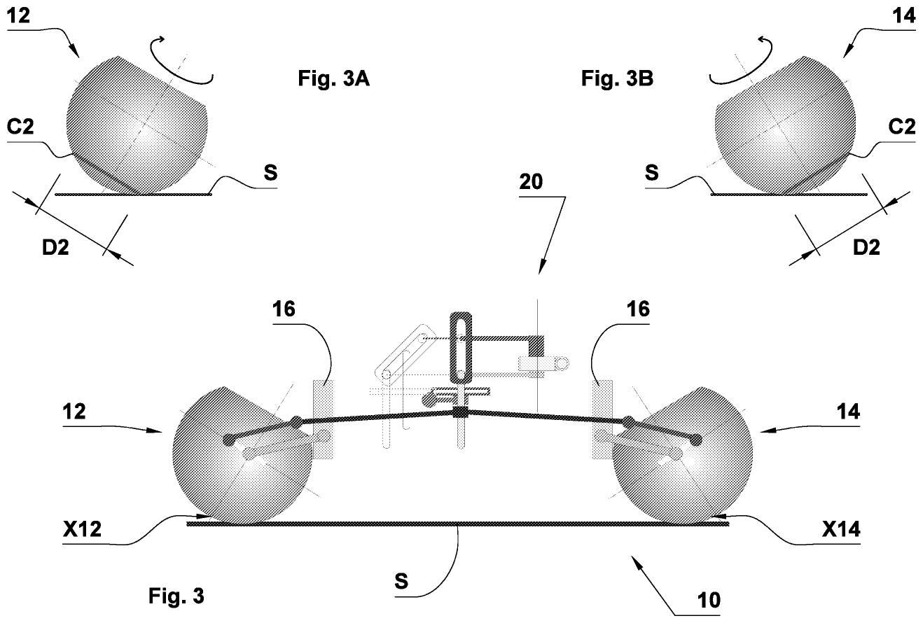

FIG. 3 shows the drive system of FIG. 2 in a second operating position for moving the system along a rectilinear direction at a second moving speed; FIG. 3A shows a first detail of FIG. 3;

FIG. 3B shows a second detail of FIG. 3;

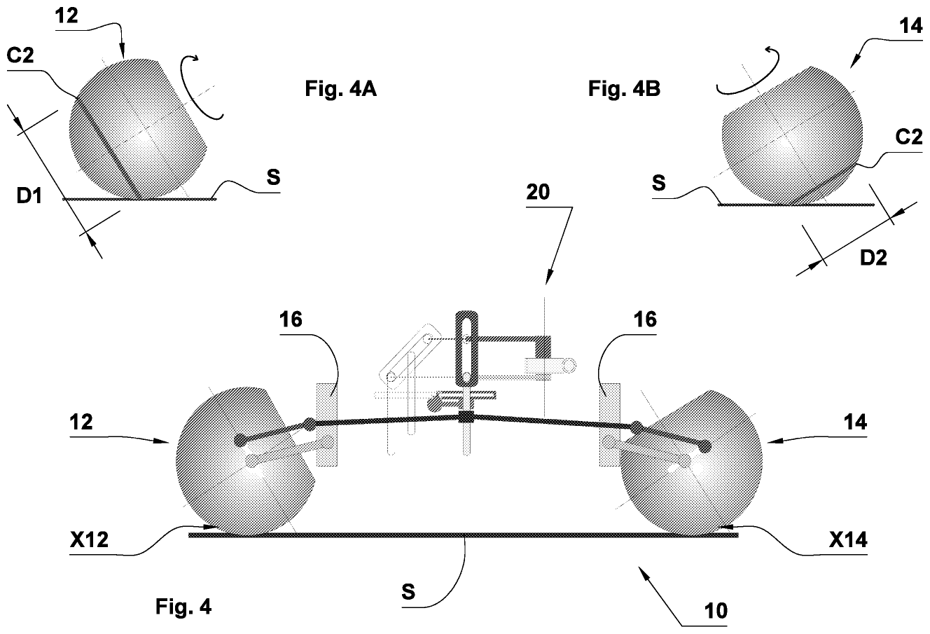

FIG. 4 shows the drive system of FIG. 2 in a third operating position for moving the system along a curved trajectory;

FIG. 4A shows a first detail of FIG. 4;

FIG. 4B shows a second detail of FIG. 4;

FIG. 5 shows a schematic view of the inclination means of a wheel for a drive system of the invention according to a preferred embodiment of the invention in a first operating position;

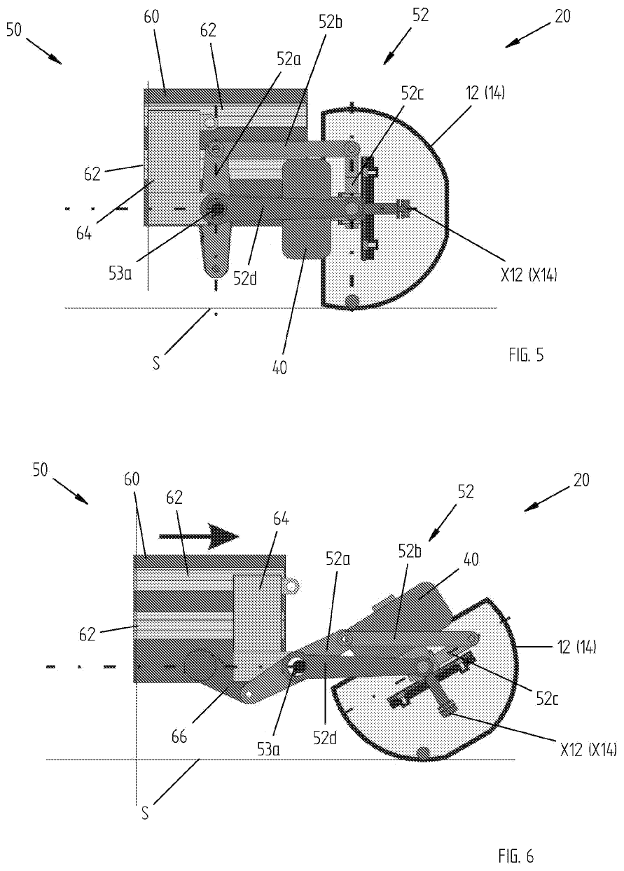

FIG. 6 shows the inclination means of FIG. 5 in a second operating position;

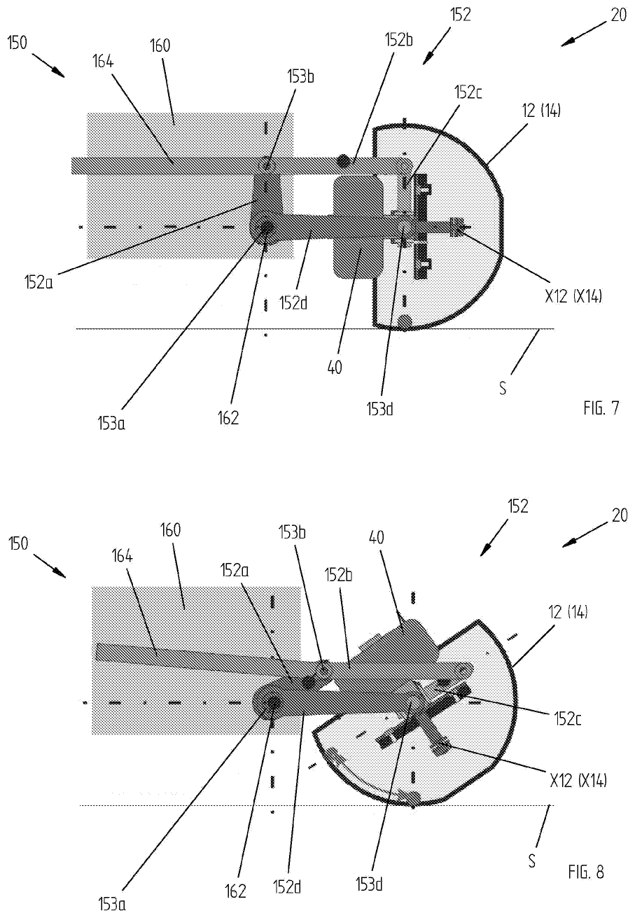

FIG. 7 shows an embodiment of the inclination means of FIG. 5 in a first operating position;

FIG. 8 shows the inclination means of FIG. 7 in a second operating position;

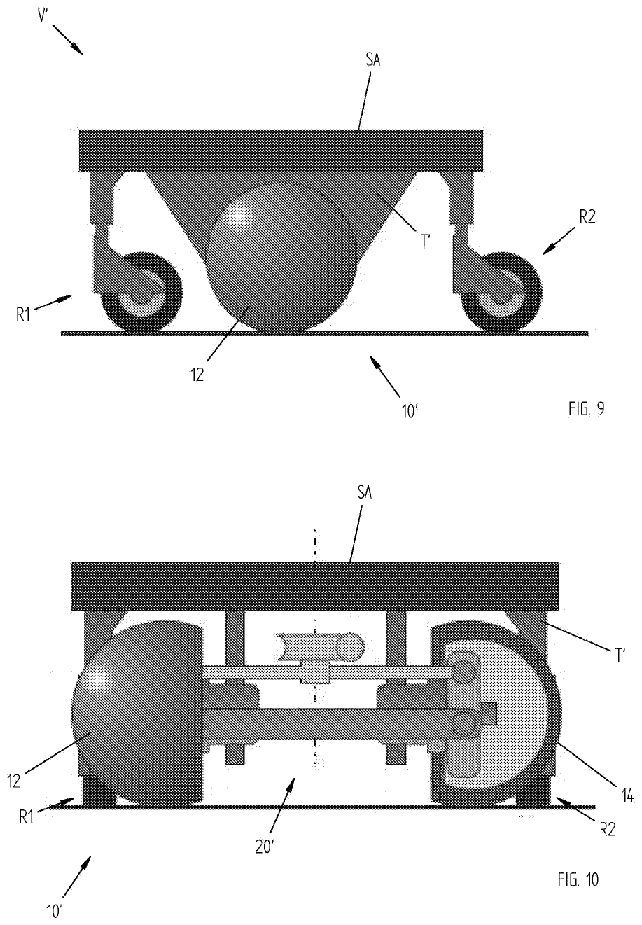

FIG. 9 shows a schematic view of another vehicle equipped with a drive system according to the invention;

FIG. 10 shows a detail of the vehicle of FIG. 9 from another point of view;

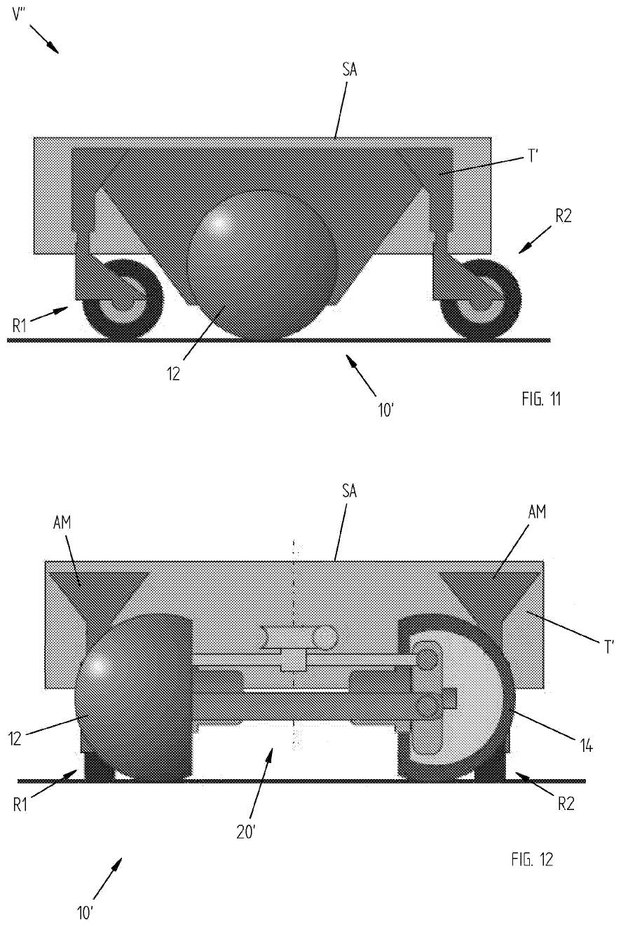

FIG. 11 shows a schematic view of a further vehicle equipped with a drive system according to the invention;

FIG. 12 shows a detail of the vehicle of FIG. 11 from another point of view.

In alternative embodiments, characteristics and/or corresponding or equivalent component parts are identified by the same reference numbers.

FIG. 1 schematically shows a drive system 10 according to a preferred embodiment of the invention installed on a vehicle V.

FIGS. 2, 3 and 4 show the drive system 10 in different operating conditions in corresponding different operating modes of the vehicle V.

The vehicle V according to the preferred embodiment shown in FIG. 1 substantially represents a passenger car, more specifically it shows the chassis of this car V equipped with two front wheels A1, A2, a steering wheel B for turning and a manual control M for speed variation. In alternative embodiments, however, the drive system 10 according to the invention may equip other types of vehicles, such as trucks, robotic systems, automated integrated systems, automated materials handling vehicles, systems for exploration and work in hazardous environments, exploration and work in the space sector, rescue and handling of persons with disabilities, operator controlled vehicles for the handling of heavy materials, remote control systems.

Applications in other types of vehicles of the drive system according to the invention are shown for example in FIGS. 9 to 12, as better described below.

In the embodiment shown in the figures, the drive system 10 is preferably associated with the rear axle of the vehicle V, to define a rear-wheel drive system, as will be better described below. In alternative embodiments, the drive system 10 may be associated with the front axle of the vehicle it equips, thus defining a front-wheel drive system or possibly both the front and rear axle for a 4-wheel drive system.

The drive system 10 comprises a first driving wheel 12 and a second driving wheel 14 associated with a support structure 16. In the illustrated embodiment, this support structure 16 corresponds to a part of the chassis of the vehicle V.

The driving wheels 12, 14 are suitably rotated, clockwise or counterclockwise, for the forward or reverse movement of the drive system 10, and therefore of the vehicle V, on a support surface S, a road for example.

The rotation of the driving wheels 12, 14 is preferably achieved by means of electric motorization means mounted directly on the wheels 12, 14, for example a first electric motor mounted on the first driving wheel 12 and a second electric motor mounted on the second driving wheel 14. In alternative embodiments, the rotation of the drive wheels 12, 14 may be obtained by means of hydraulic motorization means, for example a hydraulic motor mounted in each driving wheel 12, 14, or by means of a single motor with half-shafts and constant velocity joints moved by said single motor.

The first driving wheel 12 is rotated around a first rotation axis X12 and the second driving wheel is rotated around a second rotation axis X14.

According to an advantageous aspect of the present invention, the first driving wheel 12 is constituted by at least one spherical portion and the second driving wheel 14 is also constituted by at least one spherical portion.

In the illustrated embodiment, the driving wheels 12, 14 are substantially hemispherical. According to another advantageous aspect of the present invention, the drive system 10 comprises inclination means, generally indicated with 20, suited to vary the inclination of the first axis of rotation X12 and/or of the second axis of rotation X14 of the driving wheels 12, 14.

In the operating position shown in FIG. 2, the inclination means 20 set the first axis of rotation X12 and the second axis of rotation X14 with the same inclination with respect to the support surface S.

In this operating condition, with the wheels 12, 14 rotated at the same angular speed by the respective drive means, the drive system 10 and the associated vehicle V move forward or backward at a predetermined speed along a rectilinear direction. In this operating condition, in particular, the contact points of the support surface S with the wheels 12, 14 define on the wheels 12, 14 a rotation circumference C1 at a first diameter D1, as shown in the details of FIGS. 2A and 2B.

According to a first advantageous aspect of the present invention, the inclination means 20, simultaneously change the inclination of the first axis of rotation X12 and of the second axis of rotation X14 by the same angle, as shown in FIG. 3.

In the case shown, the inclination angle is increased. The driving wheels 12, 14 arranged in the new configuration, with the same angular speed with respect to the previous configuration of FIG. 2, cause a variation of the moving speed of the drive system 10 and of the associated vehicle V, which always occurs along a rectilinear direction.

In this operating condition, in particular, the contact points of the support surface S with the wheels 12, 14 define on the wheels 12, 14 a rotation circumference C2 with a second diameter D2, as shown in the details of FIGS. 3A and 3B.

This second diameter D2 is smaller than the diameter D1 of the previous configuration and therefore, with the same angular speed of the wheels 12, 14, the forward speed of the drive system 10 and of the vehicle V is reduced.

It is clear that in the opposite case in which the inclination of the rotation axes X12, X14 is decreased rather than increased, the speed of the drive system 10 and of the vehicle V will be increased.

In the preferred embodiment as shown in FIG. 1, the simultaneous variation by the inclination means 20 of the angles of inclination of the rotation axes X12, X14 of the wheels 12, 14 is achieved through the manual speed control M which engages the inclination means 20 by means of a suitable hydraulic transmission system 22.

It is clear that in alternative embodiments, the speed control may be of a different type, like an electronic control for example.

According to a further advantageous aspect of the present invention, the inclination means 20 of the drive system 10 set the first axis of rotation X12 and the second axis of rotation X14 of the drive wheels 12, 14 with different inclinations with respect to the support surface S, as shown in FIG. 4.

In this operating condition, with the wheels 12, 14 rotated at the same angular speed by the respective drive means, the drive system 10 and the associated vehicle V move along a curved trajectory.

In this operating condition, in particular, the points of contact of the support surface S with the left wheel 12 define on the wheel 12 itself a rotation circumference C1 with a first diameter D1, as shown in the detail of FIG. 4A, while the points of contact of the support surface S with the right wheel 14 define on the wheel 14 a rotation circumference C2 with a second diameter D2, as shown in FIG. 4B.

This second diameter D2 of the right wheel 14 is smaller than the first diameter D1 of the left wheel 12 and therefore, with the same angular speed of the wheels 12, 14, the drive system 10 and the vehicle V turn to the right Dx, as indicated in FIG. 1.

It is clear that in the opposite case in which the inclination of the left wheel 12 is greater than the inclination of the right wheel 14, the drive system 10 and the vehicle V turn to the left Sx, as indicated in FIG. 1.

In the preferred embodiment as shown in FIG. 1, the simultaneous variation by the inclination means 20 of the angles of inclination of the rotation axes X12, X14 of the wheels 12, 14 with different angles so as to turn is achieved through the steering wheel V which transmits the command to the inclination means 20 by means of a suitable mechanical transmission system 24.

It is clear that in alternative embodiments, the turning control may be of a different type, like an electronic control for example.

FIGS. 5 and 6, show a first possible embodiment of a system 50 relating to the inclination means 20 which incline the rotation axis X12, X14 of a drive wheel 12, 14, according to the methods described above.

The aforementioned figures show the driving wheel 12, 14, its axis of rotation X12, X14 and the electric drive means 40 mounted directly on the wheel itself 12, 14, preferably an electric motor.

The system 50 is defined by an articulated parallelogram 52 comprising four sides 52a, 52b, 52c, 52d, in which a short side 52c of the articulated parallelogram 52 is integral with the wheel 12, 14.

The deformation of the articulated parallelogram 52 results in the movement/inclination of the short side 52c and therefore the inclination of the axis X12, X14 of the wheel itself 12, 14, as can be deduced by comparing FIGS. 5 and 6.

More specifically, the system 50 comprises a support structure 60, for example a part of the vehicle's frame, on which sliding rails 62 are provided for a slide 64 intended to move the articulated parallelogram 52. The slide 64 is integral with a vertex 53a of the articulated parallelogram 52 while the short side 52a of the articulated parallelogram 52 opposite to the one integral with the wheel 12, 14 is secured to the support structure 60 by means of an articulation arm 66.

The right/left movement of the slide 64 above the sliding rails determines the inclination of the rotation axis X12, X14 of the wheel 12, 14, as well as a right/left translation of the wheel 12, 14 itself above the support surface S.

Therefore, in the drive system 10 according to the invention as previously described, the control for speed variation or the control for turning will suitably actuate the slide 64 to move it by the amount necessary to obtain the desired inclination of the rotation axis X12, X14 of the wheel 12, 14.

FIGS. 7 and 8 show a second possible embodiment of a system 150 relating to the inclination means 20 which incline the rotation axis X12, X14 of a drive wheel 12, 14, according to the aforementioned methods.

The aforementioned figures show the driving wheel 12, 14, its axis of rotation X12, X14 and the electric drive means 40 mounted directly on the wheel 12, 14, preferably an electric motor.

The system 150 is also defined by an articulated parallelogram 152 comprising four sides 152a, 152b, 152c, 152d, in which a short side 152c of the articulated parallelogram is integral with the wheel 12, 14. The deformation of the articulated parallelogram 152 results in the movement/inclination of the short side 152c and therefore the inclination of the axis X12, X14 of the wheel 12, 14, itself as can be deduced by comparing FIGS. 7 and 8.

In particular, the system 150 comprises a support structure 160, for example a part of the vehicle frame, on which there is an anchoring pin 162 of the articulated parallelogram at one of its vertex 153a. A control rod 164 is connected to an adjacent vertex 153b of the articulated parallelogram 152.

The right/left movement of the control rod 164 determines the deformation of the articulated parallelogram 152 and the inclination of the rotation axis X12, X14 of the wheel 12, 14. In this case, advantageously, there is no right/left translation of the wheel 12, 14 with respect to the support surface S and the wheel inclines by rotating around a vertex 153d of the articulated parallelogram 152 while maintaining the same distance with respect to the frame.

Therefore, in the drive system 10 according to the invention as previously described, the control for speed variation or the control for turning will suitably actuate the slide 164 to move it by the amount necessary to obtain the desired inclination of the rotation axis X12, X14 of the wheel 12, 14.

With reference to FIGS. 9 and 10, a drive system 10′ according to the invention is shown equipping a vehicle V′ consisting of an automated vehicle/platform for handling materials.

The platform V′ comprises a support structure, at least two idle sliding wheels R1, R2 and the drive system 10′ according to the invention with at least two driving wheels 12, 14.

The support structure T′ has an upper support surface SA on which the material to be handled can be positioned.

Preferably, the drive system 10′ according to the illustrated embodiment can be remotely controlled by means of suitable systems, for example a joystick, able to send the speed or turning variation commands to the inclination means 20′ of the drive system 10′.

With reference to FIGS. 11 and 12, a drive system 10″ according to the invention is shown equipping a vehicle V″ consisting of an automated vehicle/platform for handling materials.

This vehicle V″ differs from the vehicle V′ previously described with reference to FIGS. 9 and 10 in that it further comprises an active suspension system AM.

Therefore, with reference to the preceding description and the attached drawings the following claims are made.

The invention claimed is:

1. A moving system (10; 10′) comprising:
a first driving wheel (12);
a second driving wheel (14) each associated to a supporting structure (16) and configured to be rotated for moving said moving system (10; 10′) forward or backward on a supporting surface (S),
wherein said first driving wheel (12) comprises a first spherical portion and said second driving wheel (14) comprises a second spherical portion, said first driving wheel (12) being rotatable around a first rotation axis (X12) and said second driving wheel (14) being rotatable around a second rotation axis (X14);
an inclination system (20; 20′) configured to vary an inclination of said first rotation axis (X12) of said first driving wheel (12) and/or of said second rotation axis (X14) of said second driving wheel (14).

2. The moving system (1) according to claim 1, wherein said inclination system (20; 20′) arranges said first rotation axis (X12) and said second rotation axis (X14) with a same inclination with respect to said supporting surface (S) in order to allow said moving system (10; 10′) to move forward or backward along a rectilinear direction.

3. The moving system (1) according to claim 2, wherein said inclination system (20; 20′) varies the inclination of said first rotation axis (X12) and of said second rotation axis (X14) by a same angle at a same time, causing a variation of a moving speed of said moving system (10; 10′), a rotation speed of said first driving wheel (12) and of said second driving wheel (14) being the same.

4. The moving system (1) according to claim 1, wherein said inclination system (20; 20′) arranges said first rotation axis (X12) and said second rotation axis (X14) with different inclinations with respect to said supporting surface (S) in order to allow said moving system (10; 10′) to be moved forward or backward along a curved trajectory.

5. The moving system (1) according to claim 1, wherein said first driving wheel (12) and/or said second driving wheel is/are caused to rotate by an electric drive system (40).

6. The moving system (1) according to claim 1, wherein said first driving wheel (12) and said second driving wheel are each rotated by individual hydraulic motors or are rotated by a single motor for both wheels, with axle shafts and constant-velocity joints driven by said single motor.

7. The moving system (1) according to claim 5, wherein said electric drive system (40) is mounted directly on the first driving wheel (12) and/or the second driving wheel (14).

8. The moving system (1) according to claim 1, wherein said inclination system (20; 20′) is configured as an articulated parallelogram (52; 152).

9. The moving system (1) according to claim 1, wherein said supporting structure (16) corresponds to at least a part of a frame of a vehicle (V; V′; V″).

10. A method of controlling a trajectory and/or a moving speed of a moving system (10; 10′) according to claim 1, comprising the steps of:
arranging said first rotation axis (X12) and said second rotation axis (X14) with a same inclination with respect to said supporting surface (S) in order to allow said moving system (10; 10′) to be moved forward or backward along a rectilinear direction at a given speed or varying said same inclination of said first rotation axis (X12) and of said second rotation axis (X14) by a same extent with respect to said supporting surface (S) in order to vary the moving speed of said system (10; 10′) forward or backward along the rectilinear direction; or
arranging said first rotation axis (X12) and said second rotation axis (X14) with different inclinations with respect to said supporting surface (S) in order to allow said moving system (10; 10′) to be moved forward or backward along a curved trajectory.

11. The moving system (1) according to claim 1, wherein said moving system is installed in a vehicle (V; V′; V″).

12. The moving system (1) according to claim 11, wherein said vehicle (V; V′; V″) is selected from the group consisting of: motor vehicles, trucks, robotized systems, integrated automated systems, automated systems for material handling, exploration and operating systems for dangerous environments, exploration and operating systems for space, disabled people aid and transporting systems, heavy material handling system with human operator control, and remote control systems.

13. A method of controlling a trajectory and/or a moving speed of a vehicle (V; V′; V″) according to claim 11 comprising the following steps:
arranging said first rotation axis (X12) and said second rotation axis (X14) with a same inclination with respect to said supporting surface (S) in order to allow said vehicle to be moved forward or backward along a rectilinear direction at a given speed or to vary said same inclination of said first rotation axis (X12) and of said second rotation axis (X14) with respect to said supporting surface (S) by a same extent in order to vary a forward or backward moving speed of said vehicle along the rectilinear direction; or
arranging said first rotation axis (X12) and said second rotation axis (X14) with different inclinations with respect to said supporting surface (S) in order to allow said vehicle (V; V′; V″) to be moved forward or backward along a curved trajectory.
